(19) United States
(12) Patent Application Publication
(10) Pub. No.: US 2026/0231928 A1
(43) Pub. Date: Aug. 13, 2026

(54) TRANSCARDIAL PERFUSION PLATFORM

(71) Applicant: ARIZONA BOARD OF REGENTS ON BEHALF OF ARIZONA STATE UNIVERSITY, Scottsdale, AZ (US)

(72) Inventors: Barbara Smith, Tempe, AZ (US); Ethan Marschall, Mesa, AZ (US)

(21) Appl. No.: 19/470,893

(22) PCT Filed: Apr. 5, 2024
(86) PCT No.: PCT/US2024/023213

§ 371 Date: Sep. 30, 2025

Related U.S. Application Data
(60) Provisional application No. 63/494,309, filed on Apr. 5, 2023.

(51) Int. Cl. A01N 1/143

(52) U.S. Cl. CPC A01N 1/143

(57) ABSTRACT

A surgical platform is described. The surgical platform includes a frame having a top region and a bottom region, and further includes a support lip, a raised ridge forming an outer perimeter around the support lip, and at least one leg configured to elevate the top region relative to the bottom region. The platform also includes a surgical tray configured to releasably fit overtop the support lip and within the perimeter of the raised ridge of the frame. Lastly, the platform includes at least one flexible arm releasably attached to the frame, wherein the at least one arm includes an end effector.

### CROSS-REFERENCE TO RELATED APPLICATIONS

This application claims priority to and the benefit of U.S. Provisional Application No. 63/494,309, filed Apr. 5, 2023, the disclosure of which is incorporated herein by reference in its entirety.

### STATEMENT REGARDING FEDERALLY SPONSORED RESEARCH OR DEVELOPMENT

This invention was made with government support under Grant No. 1944846 awarded by National Science Foundation. The government has certain rights in the invention.

### BACKGROUND OF THE INVENTION

Performing surgical procedures on animals, such as transcardial perfusions, may lead to the pooling of the animal's biological fluids. The fluids will pool underneath the animal on whatever platform the operation is being performed on, which can cause a mess or raise safety and health concerns of the procedure for the animal and surgeon. For example, if the platform is flat, then the fluids will pool directly underneath the animal, which can be very unsafe and unclean. These fluids can be challenging to clean or collect in a safe and contained way during operation. Additionally, other surgical materials or parts of the animal in the procedure may become contaminated by the biological fluids, so proper collection is essential.

Moreover, transcardial perfusions may be performed on animals to utilize the blood vessels to achieve systemic delivery of a chemical substance in the living animal. To ensure a safe surgery for both the animal and surgeon, a proper surgical platform and surgical materials may be used throughout. However, pooling of the animal's biological fluids may occur on the platform during surgery, which is not only messy, but can also make cleaning up after surgery difficult. Thus, there is a need in the art for a transcardial perfusion platform, or just a surgical platform, for animal surgery that allows for easy collection and clean up; the present invention satisfies that need.

### SUMMARY OF THE INVENTION

A surgical platform is described. The surgical platform includes a frame having a top region and a bottom region, and further includes a support lip, a raised ridge forming an outer perimeter around the support lip, and at least one leg configured to elevate the top region relative to the bottom region. The platform also includes a surgical tray configured to releasably fit overtop the support lip and within the perimeter of the raised ridge of the frame. Lastly, the platform includes at least one flexible arm releasably attached to the frame, wherein the at least one arm includes an end effector. In some embodiments, the platform includes a surgical surface material covering at least a portion of a bottom surface of the surgical tray. In some embodiments, the surgical surface material is hydrophobic. In some embodiments, the hydrophobic material comprises at least one of wax, acrylic, epoxy, polyethylene, polystyrene, polyvinylchloride, polytetrafluorethylene, polydimethylsiloxane, polyester, and polyurethane. In some embodiments, the hydrophobic material is a wax. In some embodiments, the at least one flexible arm is configured to retain and hold a shape it is flexed or bent into. In some embodiments, the end effector is a clamp. In some embodiments, the end effector is an attachment mechanism for any tool, instrument, or material. In some embodiments, the at least one arm releasably attaches to a tab extending from the frame. In some embodiments, the at least one tab extends from any position around the perimeter of the frame. In some embodiments, the at least one tab may comprise at least one attachment mechanism configured to attach the flexible arm to the tab. In some embodiments, the platform includes a plurality of arms releasably attached to both the top region and the bottom region of the frame. In some embodiments, the at least one leg elevates the top region of the frame relative to the bottom region at an angle between 5° and 45°. In some embodiments, the at least one leg configuration is adjustable, such that the angle is adjustable. In some embodiments, the surgical tray comprises a wax-covered dissection tray. In some embodiments, the frame is a shape selected from the group consisting of square, rectangle, quadrilateral, polygon, circle, oval, cross, arrow, crescent, and irregular. In some embodiments, the frame has a length ranging between 10 cm and 40 cm, and a width ranging between 10 cm and 60 cm. In some embodiments, the surgical tray has a length ranging between 10 cm and 40 cm, and a width ranging between 10 cm and 60 cm. In some embodiments, the at least one flexible arm has a length ranging between 5 cm and 20 cm. In some embodiments, the frame comprises at least one of titanium, aluminum, steel, alloy, PLA, PVA, PEEK, ABS, acrylic glass, plexiglass, polycarbonate, PTFE, and PP.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A and FIG. 1B depict an exemplary embodiment of a surgical platform or system suitable for performing transcardial perfusions or other surgeries on animal models.

FIG. 2 depicts an exemplary frame and set of flexible arms of the surgical platform.

FIG. 3A, FIG. 3B, FIG. 3C, FIG. 3D, FIG. 3E, and FIG. 3F depict exemplary dimensions of the left side of the frame shown in FIG. 2.

FIG. 4A, FIG. 4B, FIG. 4C, FIG. 4D, and FIG. 4E depict exemplary dimensions of the right side of the frame shown in FIG. 2.

FIG. 5 is an exemplary 3D printing of the frame shown in FIG. 2.

FIG. 6A and FIG. 6B depict an exemplary surgical tray and surgical surface material of the surgical platform.

### DETAILED DESCRIPTION OF THE INVENTION

It is to be understood that the figures and descriptions of the present invention have been simplified to illustrate elements that are relevant for a clearer comprehension of the present invention, while eliminating, for the purpose of clarity, many other elements found in surgical platforms. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element. “About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein is a surgical platform for performing transcardial perfusions and other surgical techniques in animal models.

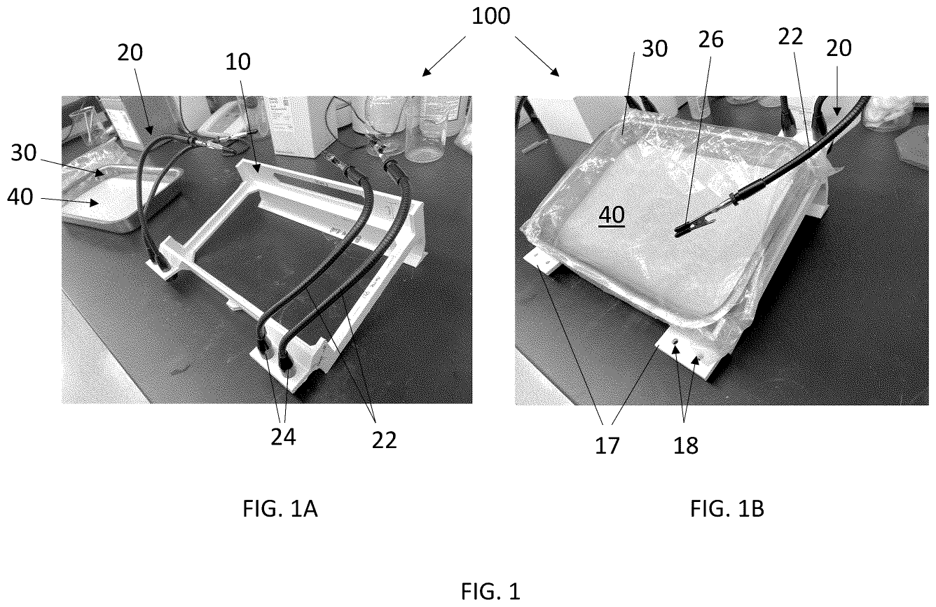

Now referring to FIG. 1A and FIG. 1B, a system or platform 100 for performing animal surgeries and techniques such as transcardial perfusion is shown. System 100 may include a frame 10, one or more arms 20, a surgical tray 30 and surgical surface material 40.

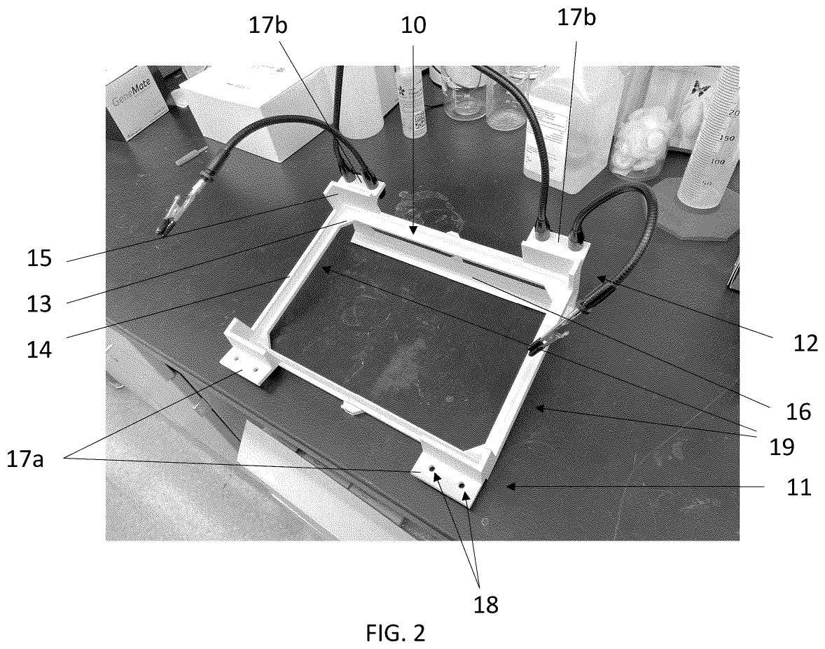

Referring also to FIG. 2, frame 10 includes a support lip 13 and a raised ridge 14 forming a perimeter in which the surgical tray 30 may sit or nest within. Support lip 13 may be any thickness and may extend inwardly at any desired length, so long as support lip 13 is sized and configured to support the bottom of surgical tray 30 placed thereon. In some embodiments, support lip 30 may be a connected floor that is either solid or contains openings, as desired. Raised ridge 14 further creates a perimeter that is sized to fully contain the surgical tray 30 when placed within it. There is no limitation to the height of raised ridge 14, so long as raised ridge 14 adequately prevents surgical tray 30 from sliding off of support lip 13. Raised ridge 14 may be sized such that surgical tray 30 fits loosely within the raised perimeter, or it may fit tightly to prevent any shifting of surgical tray 30. In some embodiments, raised ridge 14 may include elevated corners 15 which extend higher than the lengths of raised ridge 14 between the corners. Frame 10 and the perimeter formed by raised ridge 14 around support lip 13 can be any shape. For example, the shape may be generally rectangular as shown in FIG. 2, having a top region 12, a bottom region 11 and side regions 19. In some embodiments, the shape may be square, circular, oval, curved, or any random shape. In some embodiments, the shape of frame 10 may be different than the shape of the perimeter formed by raised ridge 14. It should be appreciated that the shape of frame 10 and the perimeter formed by raised ridge 14 around support lip 13 should generally correspond to the shape surgical tray 30 which will fit or nest within frame 10.

Frame 10 may also include one or more legs 16 to increase the height of one or more sections of frame 10. For example, as shown in FIG. 2, leg 16 lifts or elevates the top region 12 of frame 10 to create a tilted or angled configuration. In some embodiments, multiple legs 16 may be used to lift bottom region 11, side lengths 19, corners of frame 10 or any portion desired. In some embodiments, leg 16 may be adjustable to permit selection of variable heights. In some embodiments, leg 16 may be hingedly attached to the bottom surface of support lip 13 or to the back surface of raised ridge 14 such that leg 16 may have an open position and a closed position. Accordingly, in the open position leg 16 would elevate the height of frame 10 and in the closed position the height of frame 10 is unchanged. In some embodiments, leg 16 may be fixedly attached to frame 10. In some embodiments, leg 16 is releasably attached to frame 10. There is no limitation to the length of leg 16, and there is no limitation to the angle or tilt created by leg 16. For example, by elevating the top region 12 via leg 16, the tilt of frame 10 relative to the horizontal surface on which it is placed (e.g. the tilt angle) may be between 0° and 90°. In some embodiments, the tilt angle may be between 5° and 45°. In some embodiments, the tilt angle may be between 10° and 30°. In some embodiments, the tilt angle is at least 5°, at least 10°, at least 15°, at least 20°, at least 25°, at least 30°, at least 35°, at least 40°, or at least 45°.

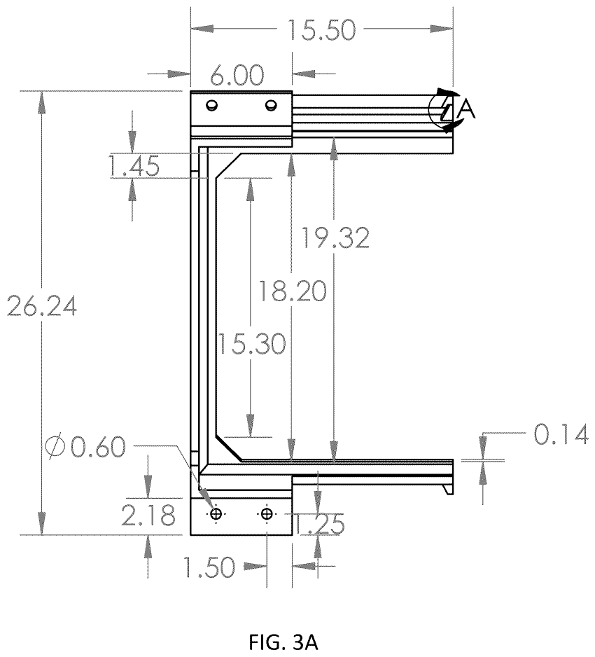

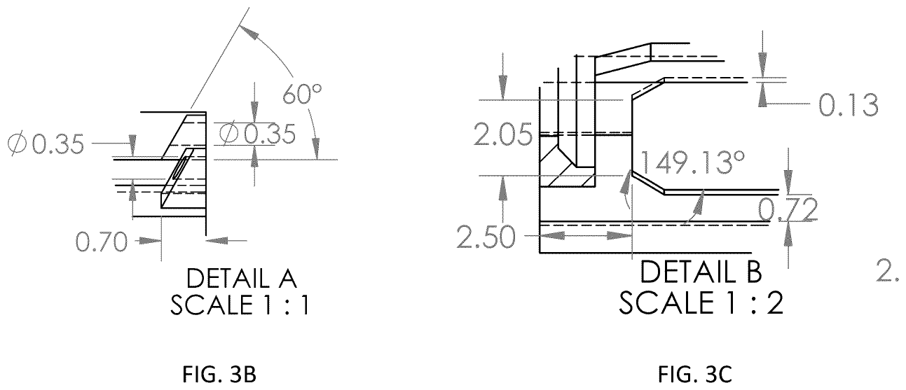

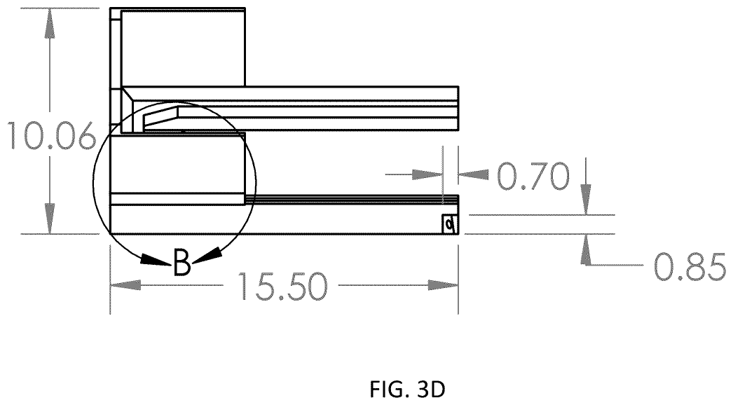

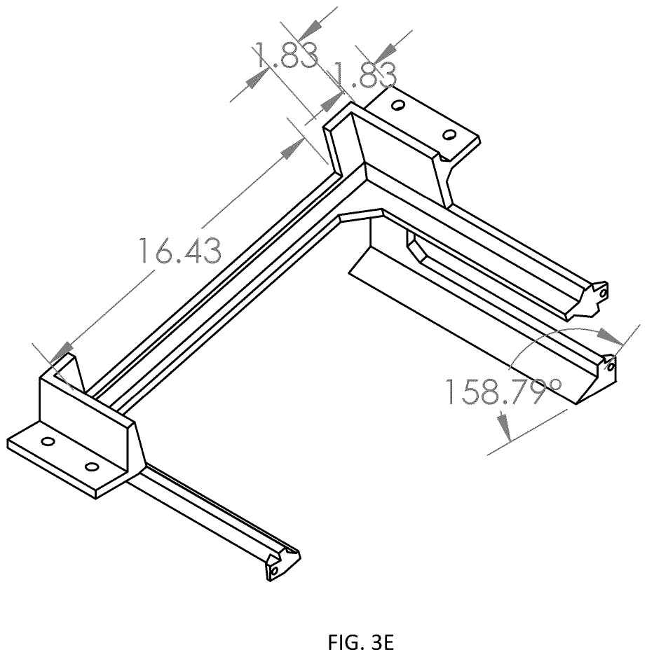

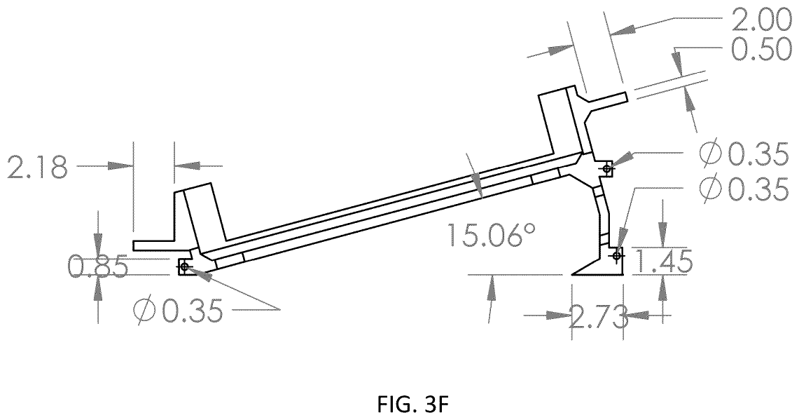

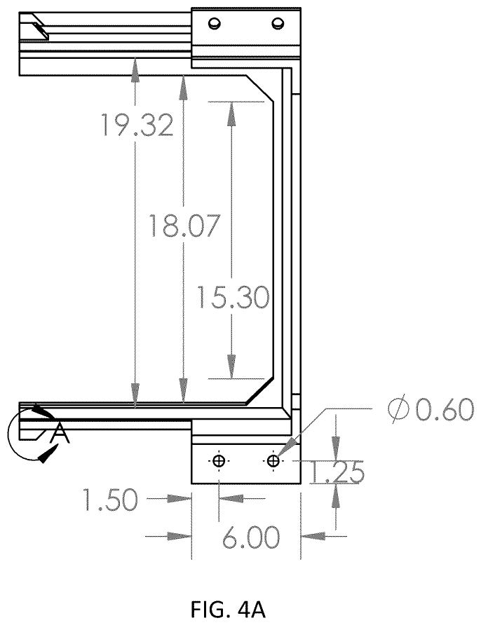

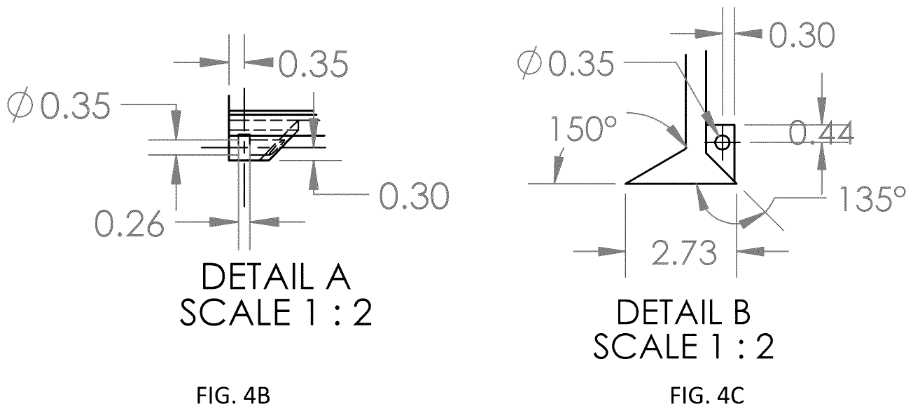

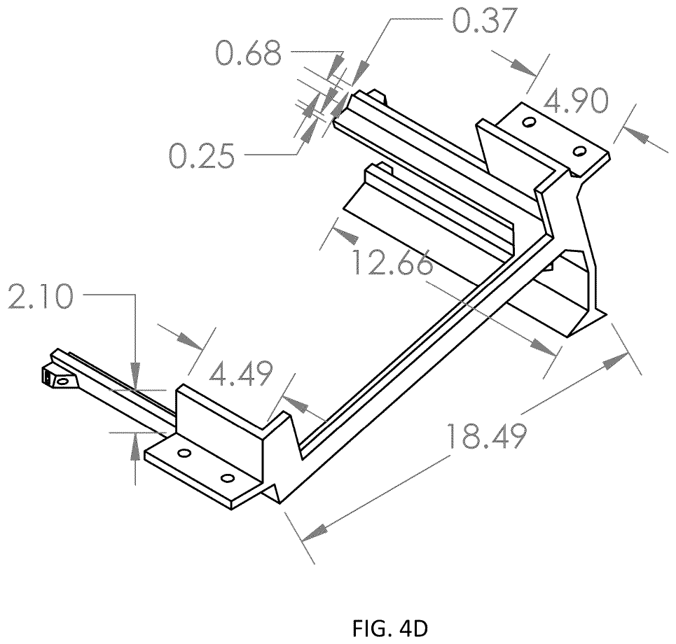

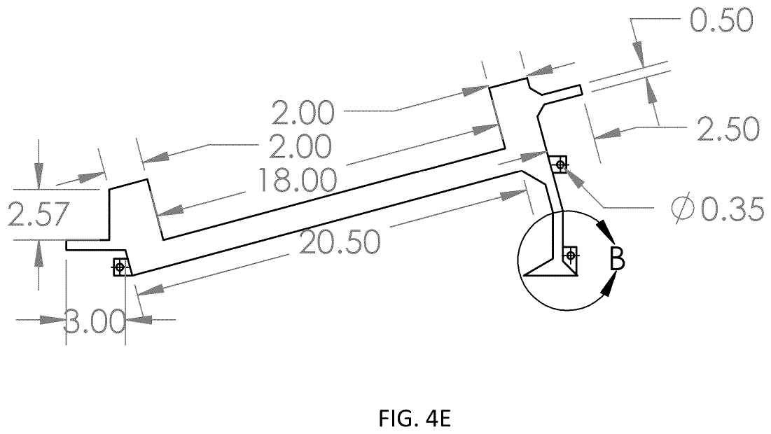

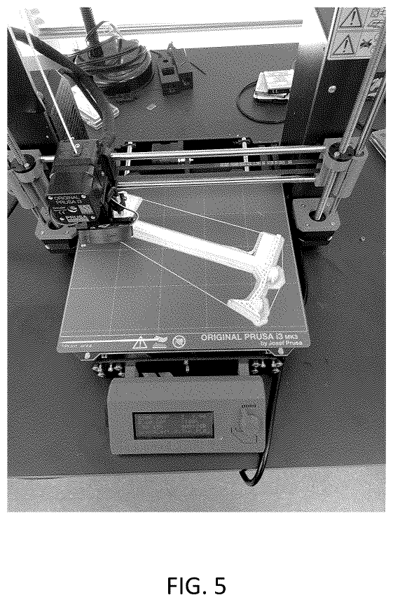

Frame 10 also includes one or more attachment region 18 for releasably and securely attaching one or more arms 20 to frame 10. In some embodiments, attachment region 18 may be include or otherwise be positioned on one or more extension tabs 17. In some embodiments, attachment regions 18 may be located on a portion of frame 10 that is not an extension tab 17. Tabs 17 generally extend outwardly from frame 10 such that attachment regions 18 are easily accessible when surgical tray 30 is positioned on frame 10. Tabs 17 may be positioned anywhere around the periphery of frame 10. For example, in some embodiments and as shown in FIG. 2, one or more tabs 17a may be positioned along the bottom region 11 of frame 10. In some embodiments and also as shown in FIG. 2, one or more tabs 17b may be positioned along the top region 12 of frame 10. In some embodiments, one or more tabs 17 may be positioned along the side lengths 19 of frame 10. There is no limit to the number of tabs 17 positioned about the periphery of frame 10. In some embodiments, there are at least four tabs 17, with at least one tab 17 in top region 12, at least one tab 17 in bottom region 11, at least one tab 17 on left side length 19 and at least one tab 17 on right side length 19. In some embodiments, a tab 17 is positioned adjacent to each corner of a generally square or rectangular frame. Any number of attachment regions 18 can be positioned within each tab 17. For example, a tab 17 may have between 0 and 10 attachment regions 18. In some embodiments, a tab may have at least one, at least 2, at least 3, at least 4, at least 5, at least 6, at least 7, at least 8, at least 9, or at least 10 attachment regions 18. Attachment regions 18 may include any type of attachment mechanism suitable for attachment of arms 20. For example and without limitation, attachment regions 18 may be threaded holes, tapered holes, detents, pins, snaps, hook and latch pads, adhesive pads, at the like. Frame 10 may be any size suitable for performing transcardial perfusions or other surgical procedures on animal models. Exemplary dimensions of frame 10 are shown in FIGS. 3A, 3B, 3C, 3D, 3E, and 3F (right half) and FIGS. 4A, 4B, 4C, 4D, and 4E (left half). Frame 10 may be composed of any type of polymer, plastic, metal, or other suitable material. Frame 10 may be manufactured by standard techniques including 3D printing (as shown in FIG. 5), injectable molding, and the like. Further, frame 10 may be manufactured as a single unit or it may be an assembly of component parts.

Arms 20 may be any type of arm or extension that is reliably and securely attachable to frame 10. For example, as shown in FIG. 1A and FIG. 1B, arms 20 may be a gooseneck clamp. Arms 20 may include an attachment end 24 with a corresponding attachment mechanism for releasably and securely engaging an attachment region 18 of frame 10. There is no limitation for how attachment end 24 ultimately engages frame 10. Arm 20 also includes an end effector 26 positioned at the working end of arm 20. End effector 26 may be a clamp or other grasping tool, or it may simply be an attachment site for engaging any tool, instrument, or material the user desires. Such materials may include, without limitation, an ice chest, a perfusion pump, a scalpel, parts of the animal, scissors, tubing, vacuum lines, filters, bottles, magnifying glass, lights, gauze, cotton-tip applicators, and the like. In some embodiments, end effector 26 may be a light or illumination source, a sensor, a probe, an electrode, a syringe, or needle, a positive or negative pressure pump or the like. Arm 20 further includes a flexible body 22. Body 22 may be any length desired, such as between 1 inch and 3 ft. In some embodiments, body 22 may have a single shape in a relaxed state, where body 22 returns to its relaxed state shape after being flexed or bent. In some embodiments, body 22 retains and holds whatever shape it is flexed or bent into. In some embodiments, body 22 of arms 20 may include a lumen through all or a portion of its length and at least one opening into the lumen. In some embodiments, arms 20 may be automated and include standard robotic arm controlling systems.

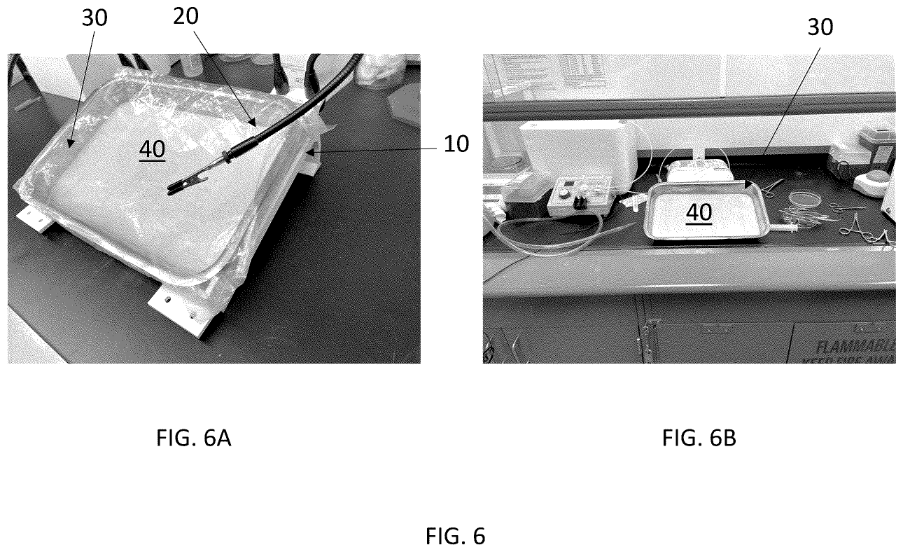

Surgical tray 30 is generally an open container having a bottom surface, sidewalls around the perimeter of the bottom surface and an open top. Surgical tray 30 may be any shape, including square, rectangular, circular, oval, curved, or any random shape. In some embodiments, surgical tray 30 is a dissection tray with or without a wax dissection surface as would be known and used by one of ordinary level of skill in the art. The size and shape of surgical tray 30 should be suitable for placement on support lip 13 and within the perimeter formed by raised ridge 14 of frame 10, as is shown in FIG. 6A. The depth of surgical tray 30 from the bottom surface to the top edge of the sidewall may be any desired depth. As contemplated herein, the depth of surgical tray 30 should be suitable for holding surgical surface material 40 and to contain any amount of fluid pooling as result of the transcardial perfusion or other surgical procedure performed within surgical tray 30. In some embodiments, surgical tray 30 may include a drainage port in the bottom surface or within a portion of the sidewall. In some embodiments, surgical tray 30 may include a drainage channel to direct the flow of pooling liquids to a designated region of surgical tray 30 or out of surgical tray 30 altogether. Surgical tray 30 may be composed of metals, polymers, or any other suitable material. In some embodiments, surgical tray 30 is autoclavable or sterilizable. In some embodiments, surgical tray 30 is a single use, disposable item.

Surgical surface material 40 may be positioned on all or portion of the bottom surface of surgical tray 30. Likewise, surface material 40 may be positioned on all or a portion of the sidewalls of surgical tray 30. In some embodiments, surgical surface material 40 is hydrophobic and thus is suitable for repelling water-based fluids or other polar solvents within surgical tray 30. Without limitation, exemplary hydrophobic or water-resistant surface materials may be waxes, acrylics, epoxies, polyethylene, polystyrene, polyvinylchloride, polytetrafluorethylene, polydimethylsiloxane, polyesters, and polyurethanes. It should be appreciated that when surgical tray 30 is positioned within frame 10 at a suitable tilted angle, all polar liquids will be repelled from the hydrophobic surface material 40 and consequently pool at the bottom edge along the sidewalls of surgical tray 30. Accordingly, in some embodiments, a suction tip or needle may be held by the end effector 26 of an arm 20 and positioned at the bottom edge of the surgical tray 30, such that any liquids pooling along this bottom edge may be continuously or periodically sucked out without the use of the practitioner's hands. In some embodiments, any vacuum system known in the art may be connected to and/or used with system 100, including but not limited to, chemical hood vacuum systems, suction flask systems, volatile chemical filter vacuums, cold trap vacuum systems, and the like.

FIG. 6B shows an exemplary surgical setup for a transcardial perfusion on an animal underneath a laboratory fume hood. Shown are various surgical materials that may be used in the procedure, including a perfusion pump, scissors, and ice chest, and a surgical tray 30 containing surgical surface material 40 and positioned on a tilted frame 10.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A surgical platform, comprising:
a frame having a top region and a bottom region, the frame further including a support lip, a raised ridge forming an outer perimeter around the support lip, and at least one leg configured to elevate the top region relative to the bottom region;
a surgical tray configured to releasably fit overtop the support lip and within the perimeter of the raised ridge of the frame; and
at least one flexible arm releasably attached to the frame, wherein the at least one arm includes an end effector.

2. The surgical platform of claim 1, further comprising a surgical surface material covering at least a portion of a bottom surface of the surgical tray.

3. The surgical platform of claims 1 or 2, wherein the surgical surface material is hydrophobic.

4. The surgical platform of claim 3, wherein the hydrophobic material comprises at least one of wax, acrylic, epoxy, polyethylene, polystyrene, polyvinylchloride, polytetrafluorethylene, polydimethylsiloxane, polyester, and polyurethane.

5. The surgical platform of claim 3, wherein the hydrophobic material is a wax.

6. The surgical platform of claims 1 or 2, wherein the at least one flexible arm is configured to retain and hold a shape it is flexed or bent into.

7. The surgical platform of claims 1 or 2, wherein the end effector is a clamp.

8. The surgical platform of claims 1 or 2, wherein the end effector is an attachment mechanism for any tool, instrument, or material.

9. The surgical platform of claims 1 or 2, wherein the at least one arm releasably attaches to at least one tab extending from the frame.

10. The surgical platform of claim 9, wherein the at least one tab extends from any position around the perimeter of the frame.

11. The surgical platform of claim 9, wherein the at least one tab may comprise at least one attachment mechanism configured to attach the flexible arm to the tab.

12. The surgical platform of claims 1 or 2, further comprising a plurality of arms releasably attached to both the top region and the bottom region of the frame.

13. The surgical platform of claims 1 or 2, wherein the at least one leg elevates the top region of the frame relative to the bottom region at an angle between 5° and 45°.

14. The surgical platform of claim 13, wherein the at least one leg configuration is adjustable, such that the angle is adjustable.

15. The surgical platform of claims 1 or 2, wherein the surgical tray comprises a wax-covered dissection tray.

16. The surgical platform of claims 1 or 2, wherein the frame is a shape selected from the group consisting of square, rectangle, quadrilateral, polygon, circle, oval, cross, arrow, crescent, and irregular.

17. The surgical platform of claims 1 or 2, wherein the frame has a length ranging between 10 cm and 40 cm, and a width ranging between 10 cm and 60 cm.

18. The surgical platform of claims 1 or 2, wherein the surgical tray has a length ranging between 10 cm and 40 cm, and a width ranging between 10 cm and 60 cm.

19. The surgical platform of claims 1 or 2, wherein the at least one flexible arm has a length ranging between 5 cm and 20 cm.

20. The surgical platform of claims 1 or 2, wherein the frame comprises at least one of titanium, aluminum, steel, alloy, PLA, PVA, PEEK, ABS, acrylic glass, plexiglass, polycarbonate, PTFE, and PP.
